(19) United States
(12) Patent Application Publication
(10) Pub. No.: US 2019/0267615 A1
(43) Pub. Date: Aug. 29, 2019

(54) OXYFLUORIDE CATHODES AND A METHOD OF PRODUCING THE SAME

(71) Applicant: The Trustees of Indiana University, Indianapolis, IN (US)

(72) Inventors: Jian Xie, Carmel, IN (US); Yadong Liu, Indianapolis, IN (US)

(21) Appl. No.: 16/289,290

(22) Filed: Feb. 28, 2019

Related U.S. Application Data
(60) Provisional application No. 62/636,304, filed on Feb. 28, 2018.

(51) Int. Cl. H01M 4/36; H01M 4/583; H01M 4/58; C01B 32/192; C01B 32/372

(52) U.S. Cl. CPC H01M 4/362; H01M 4/583; H01M 4/582; H01M 10/0525; C01B 32/372; H01M 2220/20; H01M 2220/30; C01B 32/192

(57) ABSTRACT

An improved nanocomposite cathode material for lithium-ion batteries comprising iron oxyfluoride (FeOF) nanoparticles with a conductive matrix of graphene sheets and a method of making the same. The FeOF/graphene composite may improve the specific capacity, rate capability and cycle life of the cathode. The graphene sheets may provide substrates for the FeOF nanoparticles to prevent delocalization of metallic Fe from the FeOF/graphene composite, allowing conversion back to rutile structures. The graphene sheets may be functionalized, and the FeOF nanoparticles may be coated.

### CROSS REFERENCE TO RELATED APPLICATION

This application claims the benefit of U.S. Provisional Patent Application No. 62/636,304, filed Feb. 28, 2018, titled “OXYFLUORIDE CATHODES AND A METHOD OF PRODUCING THE SAME,” the entire disclosure of which is hereby incorporated herein by reference in its entirety.

### FIELD OF THE DISCLOSURE

The novel technology relates generally to materials science, and, more particularly, to graphene-enhanced oxyfluoride cathode materials.

### BACKGROUND

Iron oxyfluoride (FeOF) is a reaction-reversable electrode material, but suffers from two major issues, low rate performance and structural instability. The electrochemical performance (specific capacity/energy, rate performance, cycle life, etc.) of FeOF has been characterized at very low current density (on the order of 50 mA/g, or 0.1 C), which is far too low for most practical applications, as power sources for EV and portable electronics typically provide 1.0 C and ⅓ C, respectively. The observed low rate performance and low specific capacity/energy is due to the low electric conductivity of FeOF, which is typical of most metal oxides and metal fluorides. Additionally, the slow Li+ ion diffusion within the FeOF nanoparticles also contributes to the low rate performance.

The other drawback mentioned above is structural instability. Although FeOF has been shown to exhibit the reversible conversion for (de)lithiation, FeOF typically undergoes about 50 cycles at 0.1 C (50 mA/g) with much lower initial capacity, on the order of 440 mAh/g. FeOF exhibits a rapid drop in capacity from initial capacity, such as from 650 mAh/g to 400 mAh/g after only a few cycles. FeOF typically loses about 90% capacity over 100 or so cycles, even at an extremely small current density (such as on the order of 0.005 mA/cm2). Although the conversion and reconversion reaction of FeOF is reversible, such huge capacity loss at such extremely small current density (which is close to the equilibrium state) is indicative of structural instability of FeOF as the cause of the performance degradation.

Thus, there is a need for stabilized FeOF electrode material having increased specific capacity and/or electrical conductivity as well as increased cycle life with decreased degradation over time. The present novel technology addresses these needs.

### SUMMARY

Graphene sheets are incorporated into the nanostructure of metal oxyflourides to render the conversion reaction of metal oxyfluorides (e.g., FeOF) reversible as well as increase specific capacity, specific energy, rate capability, cycleability, and/or safety. Relatively low electric conductivity, crystal structure stability and the relocation of metal nanoparticles are common issues for all of metal oxides and metal oxyfluorides, and the incorporation of graphene sheets into nanostructure of these oxides and oxyfluorides allows for tailoring the structure of materials and developing next generation of battery materials for energy storage and other applications. By incorporating graphene sheets into the FeOF microstructure/nanostructure, the theoretical specific capacity (590 (2 e−) and 885 (3 e−) mAh/g), 1720 Wh/kg, and 150 cycles (with 80% initial capacity) have been observed.

One advantage of the graphene modification of FeOF materials is that a simple effective incorporation of the graphene sheets can significantly change the materials in terms of morphology, structure and performance. The incorporation of graphene, in particular functionalized graphene, provides an effective and robust tool for tailoring the materials to achieve specifically desired properties (i.e. surface hydrophobic, intra/interparticle electric conductivity, particle size and morphology, and the like) while producing a material that remains cost effective.

High-quality graphene with high surface area may be made by the simple oxidation of natural graphite powders.

According to an embodiment of the present disclosure, a composite electrode material is provided including a plurality of graphene sheets, and a plurality of FeOF nanoparticles anchored to each graphene sheet.

According to another embodiment of the present disclosure, a battery is disclosed including the composite electrode material.

According to yet another embodiment of the present disclosure, a method of manufacturing a composite electrode material is disclosed including comprising: preparing a solution comprising FeSiF₆ and graphene oxide in a solvent; heating the solution to convert the FeSiF₆ to FeOF; and reducing the graphene oxide to graphene.

### DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 schematically illustrates charge/discharge curves for FeOF and a FeOF/graphene composite.

FIG. 2 includes: scanning electron microscope (SEM) photomicrographs of (a) FeOF/graphene composite and (c) FeOF; transmission electron microscope (TEM) images of (b) FeOF/graphene composite and (d) FeOF; and diffraction pattern images of (e) FeOF/graphene composite and (f) FeOF.

FIG. 3 is a schematic illustration of the rutile core-shell structure of FeOF in (a) a pristine rutile state, (b) a lithiated state, and (c) a delithiated state.

FIG. 4 schematically illustrates the synthesis of the FeOF/graphene composite.

FIG. 5 is a graphical representation of the electronic structure of graphene.

FIG. 6 is a schematic illustration of (a, b) the rocksalt crystal structure and (c, d) the rutile crystal structure of FeOF.

FIG. 7 is a schematic illustration of the synthesis of polyaniline (PANI) coated FeOF/graphene composite.

FIG. 8 schematically illustrates the valence change in FeOF during charge/discharge cycles for FeOF and FeOF/graphene composite materials, specifically (a) FeOF during initial discharge, (b) FeOF during initial charge, (c) FeOF/graphene during initial discharge, (d) FeOF/graphene during initial charge, (e) FeOF during discharge after 10 cycles, (f) FeOF during charge after 10 cycles, (g) FeOF/graphene during discharge after 10 cycles, and (h) FeOF/graphene during charge after 10 cycles.

FIG. 9 graphically illustrates TEM diffraction patterns of (a) FeOF and (b) FeOF/graphene composite.

FIG. 10 illustrates electron energy loss spectroscopy (EELS) images of FeOF/graphene particles after first lithiaton and delithiation cycles.

FIG. 11 is a graph of X-ray absorption spectroscopy (XAS) spectrum of the discharge process of FeOF.

FIG. 12 is a contour plot for in-situ FeOF X-ray absorption near edge structure (XANES) spectra and a charge/discharge profile.

### DESCRIPTION OF PREFERRED EMBODIMENTS

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

### I. Brief Overview of Lithium Oxide Battery Technology

Lithium ion batteries (LIBs) play a critical role in our life today. Ranging from portable electronics (i.e. cellphone, iPad, laptop, etc.), medical devices (e.g. pacemakers, Holter monitor, remote patient monitoring systems, sensors etc.), the transportation (e.g. electric vehicles (EVs) and hybrid electric vehicles (HEVs)), military equipment (i.e. unmanned underwater vehicles, radio, etc.) and many other applications, all needs the power supplies with high specific capacity/energy. Lithium has the lowest density among all metals, 0.534 g·cm⁻³, is the lightest metal, and has the most negative reduction potential, −3.05V (vs. standard hydrogen electrode potential). The low density and the negative potential give lithium metal the highest theoretical specific capacity, 3861 mAh g⁻¹ (compared to 372 mAh g⁻¹ of the carbon anode in LIBs) while the negative potential allows the construction of a battery with high open-circuit voltage. This combination of high capacity and negative potential consequently leads to high energy density batteries. However, lithium metal suffers the poor cycle life when Li metal is used as the anode in a rechargeable battery coupled with a metal oxide as the cathode. This poor cycle life is caused by the Li dendrites which grow with the charge/discharge cycle and eventually, penetrate through the separator to reach cathode and consequently, causing the short-circuit, thermal-run away and smoke and/or fire.

In 1991, the first commercial LIB was introduced, which replaced the Li metal with graphite anode and used the LiCoO₂ as the cathode. When the cell is charging, Li⁺ ions leave the LiCoO₂ electrode (i.e., delithiation of LiCoO₂), diffuse through the liquid electrolyte and enter the graphite (i.e., lithiation of graphite). When the cell is discharging, the Li⁺ ions diffuse out the graphite, diffuse through the liquid electrolyte, then enter the CoO₂. In such a process, the Li⁺ ions always remain in ionic state, while the graphite and CoO₂ experience the oxidation state change. The LiCoO₂ gradually becomes CoO₂ and at the end of the charging process, LiCoO₂ completely transforms into CoO₂ while the Co³⁺ ions in LiCoO₂ gradually changes to Co²⁺ ions in the CoO₂ host and at the end of the charge process, only Co²⁺ ions exist in the CoO₂ host. Such a battery behaves like a rocking chair in which Li⁺ ions swing back and forth between graphite anode and CoO₂ cathode during the charge and discharge process. (Practically, only ½ Li can be reversibly intercalated/deintercalated). Therefore, LIB is also called “Rocking Chair Battery”.

The specific capacity and specific energy of a LIB cell depend on the anode and cathode materials. With the rapid development of the portable electronics and the EVs/HEVs, the demand for higher specific energy batteries becomes more urgent than ever. In order to meet these demands, it is highly desired to develop novel electrode materials. As anode materials offer a higher Li-ion storage capacity (e.g. theoretical specific capacity, 372 and 4200 mAh/g for graphite, and nanostructured Si, respectively) than cathodes do (e.g. theoretical specific capacity, 272 and 175 mAh/g for LiCoO₂ and LiFePO₄, respectively), the cathode material is the limiting factor in the performance of LIBs.

### II. Cathode Materials for LIBs

Most of the cathode materials for LIBs are transition metal compounds, oxides, or complex oxides. Such transition metal compounds have layered (e.g. LiCoO₂), spinel (e.g. LiMn₂O₄) or olivine (e.g. LiFePO₄) crystal structures, and transition metal cations typically display four- and/or six-fold coordination with oxygen anions, anionic clusters, or ligands. Lithium ions are inserted via an electrochemical intercalation reaction. While lithium ions occupy the space between adjacent layers or unoccupied octahedral or tetrahedral sites, an equal number of electrons enter the available d orbitals of the transition metal cations in the host crystal. Essentially, the oxidation state of metal ions keep change with the (de)insertion accompanying the phase change of these compounds while the Li⁺ ions remain in ionic state. These materials have some common characteristics: (1) chemical stability, (2) structural stability and (3) channels allowing the effective diffusion of Li ions within the solid oxides. The chemical stability of the cathode material ensures that the host of the cathode does not decompose during the (de)lithiation process while structural stability allows the repeated (de)intercalation of Li⁺ ions into the lattices of the host materials. Channels within the materials lead to the high rate (de)lithiation process within the materials, which in turn is essential for the high rate performance of LIBs. To achieve the high specific energy (Wh/kg), cathode materials need to have high specific capacity (mAh/g), which is the capacity for storing Li⁺ ions within the metal oxides. Additionally, the cathode materials are desired to have high potential (vs. Li/Li⁺⁾ because the specific energy is the product of cell voltage and specific capacity.

The factors for high specific energy cathode materials are (1) high specific capacity (capacity of Li⁺ ion storage), and (2) the high electrochemical potentials (vs. Li/Li+). Two approaches have been taken for developing high specific energy cathode materials: (1) materials with transition metal ions capable of multi valence changes (e.g. V and Mn) and (2) materials with high potentials (vs. Li+/Li). For instance, V₂O₅ has the theoretical specific capacity of 443 mAh/g and is the highest in all cathode materials for Li⁺ intercalation reaction. This is because V⁵⁺ in the V₂O₅ molecule can have up to 3 oxidation state changes, V⁵→V⁴⁺, V⁴→V³⁺ and V³→V²⁺; correspondingly, V₂O₅ has the high ion storage capacity, namely, each V₂O₅ molecule can hold up to 3 Li⁺ ions. The V₂O₅ materials have not been used as practical LIB cathode materials due to (1) the low electric conductivity, and (2) structural stability, which are common for most of metal oxides. The low electric conductivity leads to the (1) low specific capacity because some of regions with slippery grain boundaries of V₂O₅ in a particle can't be reached at normal charge/discharge rate (i.e. 0.3 or 1.0 C rate), a low utilization leads to a typical specific capacity, around 250 mAh/g; on other hand, (2) the V₂O₅ cathode can't be operated at high charge/discharge rate. In addition, (3) some irreversible phase changes accompany the charge/discharge processes, which leads to poor cycle life. Overall, for developing high specific capacity cathode materials, multi valence metal-based compounds are critical.

Another approach for achieving high specific energy is to develop the metal oxides with high voltage. Many metal oxides have been investigated, such as Li₁₋ₓMn_{2-y}M_{y}O₄, Li₁₋ₓCo_{1-y}M_{y}O₂, Li₁₋ₓNi_{1-y-z}CO_{y}M_{z}O₄ (M=Mg, Al . . . ). Recent work focuses on the ternary metal oxides, Li₁₋ₓNi_{1-y-z}Co_{y}M_{z}O₄ (LiNCM, M=Mn, Mg, Al . . . ) which have very high voltages. However, there are some structural stability issues as they undergo deep discharge and cause the rapid performance decay upon cycling. In addition, the NCM based cathodes typically require much higher charging voltage to reach the fully charged state. Such high charging voltage requires the use of the electrolyte systems with up to 6 V electrochemical windows which needs solvents with much wider electrochemical window (e.g. fluorinated carbonates, sulfone based solvents and nitrile based solvents) or additives. There is a potential safety hazard when a LIB cell of NCM is charged at such high voltage, which could lead to the decomposition of the organic solvent in the electrolyte and consequent thermal-run away.

Transition-metal oxides, fluorides and oxyfluorides have attracted a lot of interest due to their ability to deliver high electrochemical specific energy arising from 2-3 electrons transferred.

There are quite few choices of 3d-transition metals for multi valence metal oxides, namely Ti, V, Cr, Mn, Fe, Co, Ni Cu, etc. With the exception of their electrochemical potentials and Li ion storage capacity (specific capacity), the toxicity and cost are two other important factors. Among all of these transition metals, Fe is the most abundant, nontoxic, and low-cost materials. However, Fe in either Fe₂O₃ or FeF₃, can only have one oxidation state change (i.e. Fe³⁺→Fe²⁺) during the intercalation reaction. To further increase its specific capacity, one would logically think that, if the oxidation state can be further changed from 1 valence change (i.e. Fe³⁺→Fe²⁺) to 3 valence change, namely, Fe³⁺→Fe²⁺, Fe²⁺→Fe, this in turn, will lead to total 3 Li⁺ ion storage capacity. This 3-valence change results in the reduction of Fe³⁺ to Fe⁰, which is called the conversion reaction as shown below.

FeF₃+3 Li↔Fe+3LiF (theoretical capacity: 712 mAh/g, E⁰=3.44 V)

Among the transition-metal oxides, Fe₂O₃ has attracted much attention due to its high theoretical specific capacity (1005 mAh/g), low cost, and non-toxicity. However, Fe₂O₃ has relatively low potential vs. Li/Li⁺, and the Fe₂O₃ particles suffer from rapid capacity fading because of the low conductivity and strong aggregation during the charge and discharge processes. On the other hand, FeF₃ has much higher potential 0.75 V higher than Fe₂O₃), but lower capacity (712 mAh/g).

In order to combine the advantages of both materials, a mixed-anion FeOF was proposed as a promising candidate because it has a high theoretical specific capacity of 885 mAh/g (3-electron process) and 590 mAh/g (2-electron process), leading to an exceptionally high theoretical specific energy of 2938 Wh/kg and 1958 Wh/kg for 3- and 2-electron reactions respectively. However, the electrochemical performance of FeOF is drastically different in practice due to its low electronic conductivity and poor structure stability during charge/discharge cycling process.

The performance characteristics of various cathode materials are summarized in Table 1 below.

TABLE 1

| | | | | | FeOF | FeOF |
|---|---|---|---|---|---|---|
| Cathode Type | | LiMn₂O₄ | LiCoO₂ | LiFePO₄ | (2 electron) | (3 electron) |
| Discharge Potential | Theoretical | 4.0 | 3.8 | 3.3 | 3.3 | 3.3 |
| (V vs Li/Li⁺) | Practical | 4.0 | 3.8 | 3.3 | 2.7 | |
| Specific Capacity | Theoretical | 274 | 272 | 175 | 590 | 885 |
| (mAh/g) | Practical | 120 | 145 | 150 | 637 | |
| Specific Energy | Theoretical | 1096 | 1034 | 578 | 1947 | 2921 |
| (Wh/kg) | Practical | 480 | 551 | 495 | 1720 | |
| Energy Density | Theoretical | 2926 | 2584 | 751 | 8917 | 13375 |
| (Wh/l) | Practical | 1281 | 1378 | 644 | 7877 | |
| Relative Cost | | 30 | 60 | 30 | 30 | 30 |
| ($/kg) | | | | | | |

### Mechanism of (De)lithiation of FeOF

The first cycle of FeOF lithiation and delithiation is different from the following cycles. During the lithiation, FeOF undergoes the intercalation of Li⁺ ions into FeOF first, followed by the conversion into a lithiated nanocrystalline rock salt (Li—Fe−O−F) structure, metallic Fe and LiF phases. During the delithiation, the rock salt phase does not disappear, but co-exists up to the end of delithiation with an amorphous rutile type phase formed initially by the reaction of LiF and Fe. In addition, a de-intercalation stage is still observed at the end of reconversion similar to a single-phase process despite the coexistence of these two (nanocrystalline rock salt and amorphous rutile) phases. After the first cycle, the process is the intercalation followed by the conversion into a nanoscale intermixing of the two (amorphous rutile and nanocrystalline rock salt) phases, finally a nanocomposite of metallic Fe⁰, LiF, and rock salt Li—Fe−O(—F).

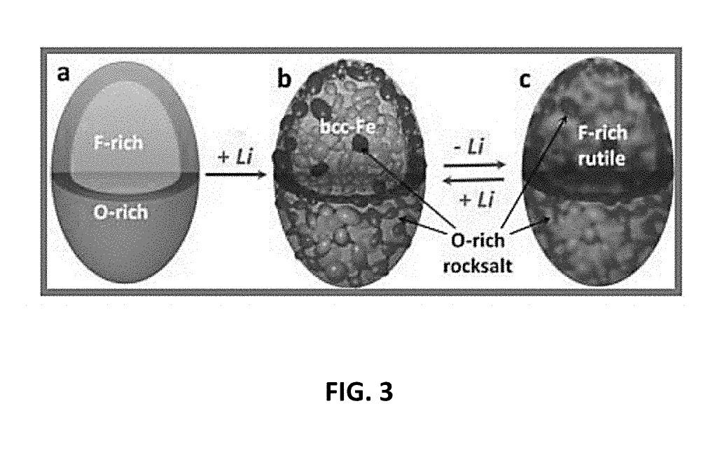

The structural/chemical ordering of FeO_{0.7}F_{1.3} is illustrated in FIG. 3. The FeO_{0.7}F_{1.3} particle is initially a single crystalline, pristine rutile with a core-shell structure that is F-rich at the core and O-rich at the shell (FIG. 3a). In the lithiated state, the particle is transformed into a nanocomposite having a body centered cubic (bcc) Fe⁰ core and an O-rich rock salt Li—Fe—O(—F) shell with average thickness of 1.0-3.0 nm (FIG. 3b). In the delithiated state, the particle has a F-rich rutile core and an O-rich rock salt shell (FIG. 3c) After the first cycle, the overall morphology and core-shell structure of F-rich rutile core and O-rich rock salt shell are maintained (although the two phases became highly disordered) during the lithiation and delithiation process.

### Capacity Fade Mechanism of LeOF

For the fully delithiated electrodes, the FeOF has the structure of the nanoscale intermixing of amorphous rutile and nanocrystalline rock salt phases and such a structure is stable up to 20 cycles. However, upon further cycling, the amount of amorphous rutile phase decreased while the amount of rock salt phase increased gradually, suggesting the incomplete reconversion reactions with cycle number. Additionally, the solid electrolyte interphase (SEI) layer grows with the cycles, which is mainly composed of LiF. Fe²⁺ and Fe nanoparticles were trapped in the SEI layer with cycles. Finally, upon cycling, the combined progressive increase in Fe²⁺ content and insulating LiF (from SEI and conversion product) is responsible to capacity loss. The catalytic interaction of nanosized metallic particles (i.e., Fe⁰) with the electrolyte, which is believed to be the main reason underlying the decomposition of the electrolyte on the particle's surface, contributes to the capacity loss.

### Electrochemical Performance of LeOF

As noted above, FeOF presents two major issues, (1) low rate performance and (2) structural stability. The electrochemical performance (specific capacity/energy, rate performance, cycle life, etc.) of FeOF is poor at very low current density (i.e. 50 mA/g, or 0.1 C), which makes FeOF a poor choice for practical applications, as power sources for EV and portable electronics usually require for batteries working at 1.0 C and ⅓ C, respectively. The cause of the low rate performance and low specific capacity/energy is due to the low electric conductivity of FeOF, which is common for most metal oxides and metal fluorides. Additionally, the slow Li⁺ ion diffusion within the FeOF nanoparticles also contributes to the low rate performance. Another issue is the structural stability. FeOF is characterized by reversible conversion for FeOF (de)lithiation, FeOF is typically only good for 50 or so cycles at 0.1 C (50 mA/g) with much lower initial capacity, 440 mAh/g. FeOF also experiences a rapid capacity drop from initial capacity, 650 mAh/g to 400 mAh/g after only a few cycles. Although the conversion and reconversion reaction of the formed FeOF is reversible, such huge capacity losses at such extremely small current densities (which are close to the equilibrium state) suggests the FeOF structural stability is the cause of the performance degradation.

The performance of an electrode material is always rooted in its structure. Understanding the structure change of FeOF and the mechanism of (de)lithiation allows developing FeOF cathode materials.

### III. Graphene Incorporated Nano-Structured FeOF Materials

To overcome the above-described challenges of FeOF, conducting graphene matrices have been introduced into the FeOF nanoparticles. The graphene may improve the electric conductivity of the FeOF particles, provide a substrate for the FeOF particles, and absorb the volume changes and to improve the structural stability of the electrodes.

The low electric conductivity of FeOF is one of the major causes for the low rate and low specific capacity. In addition, to facilitate the fast Li⁺ ion conversion reaction and increase the utilization of FeOF materials during conversion reaction, the high surface area of FeOF particles is desired for Li⁺ ion access, namely, uniform and small nanoparticles. To increase the reversibility of the conversion reaction, it is helpful to provide a substrate for the FeOF particles to anchor on so that the formed Fe nanoparticles at the end of the lithiation process do not delocalize, allowing that the intermixing of the amorphous rutile and nanocrystalline rock salt phases and the metallic Fe nanoparticles (core-shell structure with O-rich rock salt shell and bcc-Fe⁰ core) can go back to the core-shell structure of O-rich rock salt shell and F-rich rutile as shown in FIGS. 3b and 3c.

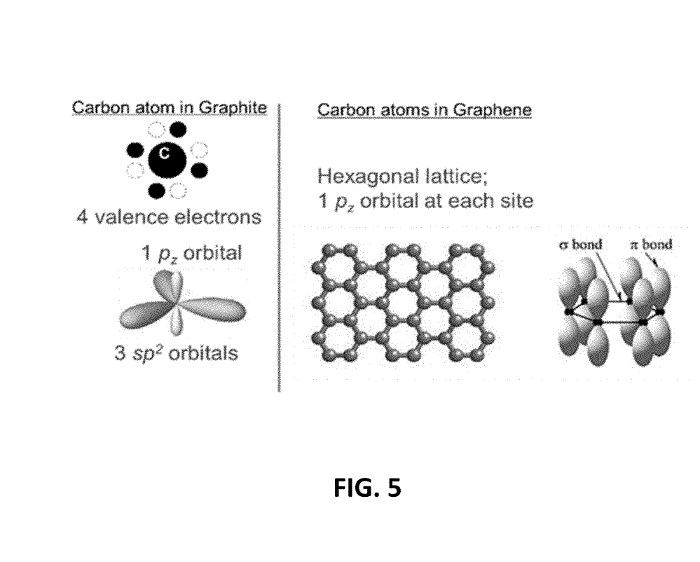

Graphene has been considered as one of the most attractive carbon materials for its excellent charge carrier mobility, mechanical robustness and thermal and chemical stability. As shown in FIG. 5, graphene is a single atomic layer of sp²-bonded carbon atoms arranged in a honeycomb crystal structure and can be viewed as an individual atomic plane of the graphite structure. In graphene, each carbon atom uses 3 of its 4 valance band (2s, 2p) electrons (which occupy the 3 sp² orbits) to form 3 covalent bonds with the neighboring carbon atoms in the same plane. Each carbon atom in the graphene contributes its fourth lone electron (occupying the p_{z} orbit) to form a delocalized electron system, a long-range π-conjugation system shared by all carbon atoms in the graphene plane. Such a long-range i-conjugation in graphene yields extraordinary electrical (i.e. extremely high electric conductivity, 6.29×10⁷ S/cm), mechanical (i.e. fracture strength ˜130 GPa), and thermal properties (i.e. 3000 W/m−K in plane). One issue for graphene is to keep it as a single sheet since these graphene sheets tends to re-stack back to graphite structure which form multi-layer graphene stack, resulting in the loss of the unique characteristics (i.e. high electric conductivity, etc.).

Graphene can be prepared using the chemical or thermal reduction of graphene oxide (GO), which is a layered stack of oxidized graphene sheets with different functional groups. Thus, GO can be easily dispersed in the form of single sheet in water at low concentrations. The cost of GO is very low (e.g. estimated $10-20/kg from chemical oxidation of nature graphite method), hence the incorporation of graphene into the metal oxide nanoparticles should not result in significant additional cost since only very small amount of graphene is used. The key is to control the low concentration of GO to avoid the restacking of the GO sheets, which leads to the diminishing of the unique properties of graphene.

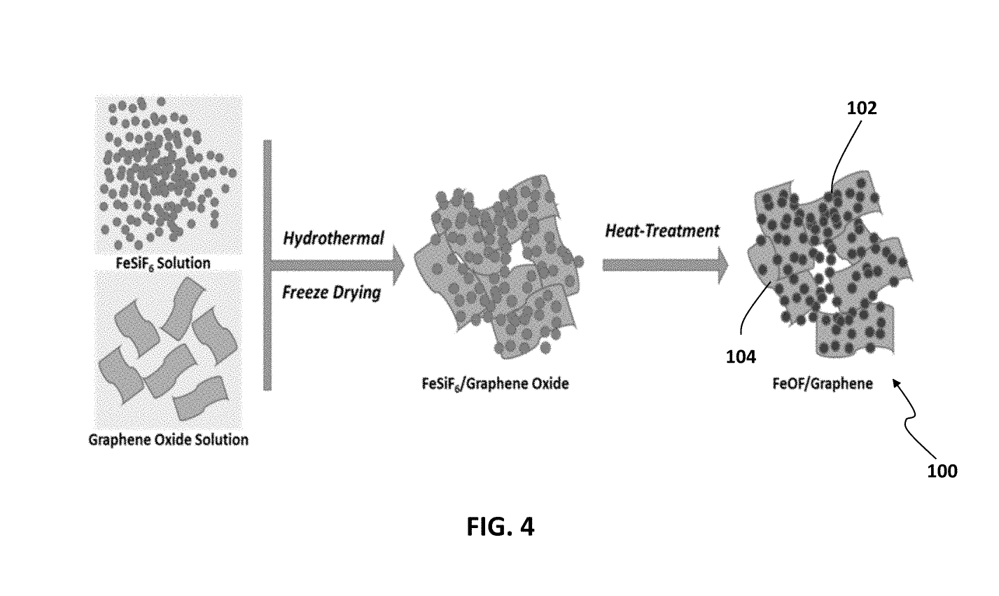

An exemplary solution-based solvothermal method is shown in FIG. 4 for synthesizing the FeOF/graphene composite material. First, a FeOF precursor solution, specifically FeSiF₆.6H₂O, is prepared. In one embodiment, a high-purity iron metal powder is treated with aqueous hexafluorosilicic acid (H₂SiF₆) solution, stirred at a temperature of about 40-55° C., and filtered to obtain the FeSiF₆ solution. Next, the FeOF precursor solution is mixed with a dilute graphene oxide (GO) solution. The graphene oxide may be present in the mixture at a desired weight percentage of about 0.1-70 wt. %. The graphene oxide may have desired functional groups, as described in Section IV below. The mixture is heated to a suitable temperature of about 120° C. to form FeF₂ according to Reaction (1) below, and then the FeF₂ is further heated to a temperature of about 200-240° C. for 5-20 hours under 02 gas flow to form FeOF according to Reaction (2) below. The solvent for the solvothermal method can be, but is not limit to, water, methanol, ethanol, N-Methyl-2-pyrrolidone (NMP), benzyl alcohol, and the like, and/or mixtures thereof.

FeSiF₆·6H₂O→FeF₂+SiF_{4 (gas)}+6H₂O_{(gas)} (1)

FeF₂+O_{2 (gas)}→FeOF (2)

The FeOF product was then freeze-dried/spray-dried and heat-treated in a tube furnace with temperature of about 200-350° C. for about 1-12 hours to reduce the GO to graphene. The various method steps, including the temperatures, times, concentration of precursor FeSiF₆, and concentration of graphene oxide, may be controlled and optimized to obtain FeOF nanoparticles with small diameter.

In the illustrated embodiment of FIG. 4, the resulting FeOF/graphene composite 100 is a cage structure having FeOF nanoparticles 102 dispersed over graphene sheets 104. The FeOF nanoparticles 102 and the graphene sheets 104 may formed a layered structure so that the graphene sheets 104 function like a cage to hold the FeOF nanoparticles 102. The graphene sheets 104 may account for about 1-10 wt. %, more specifically about 2-8 wt. %, of the total composite 100, which may resist re-stacking.

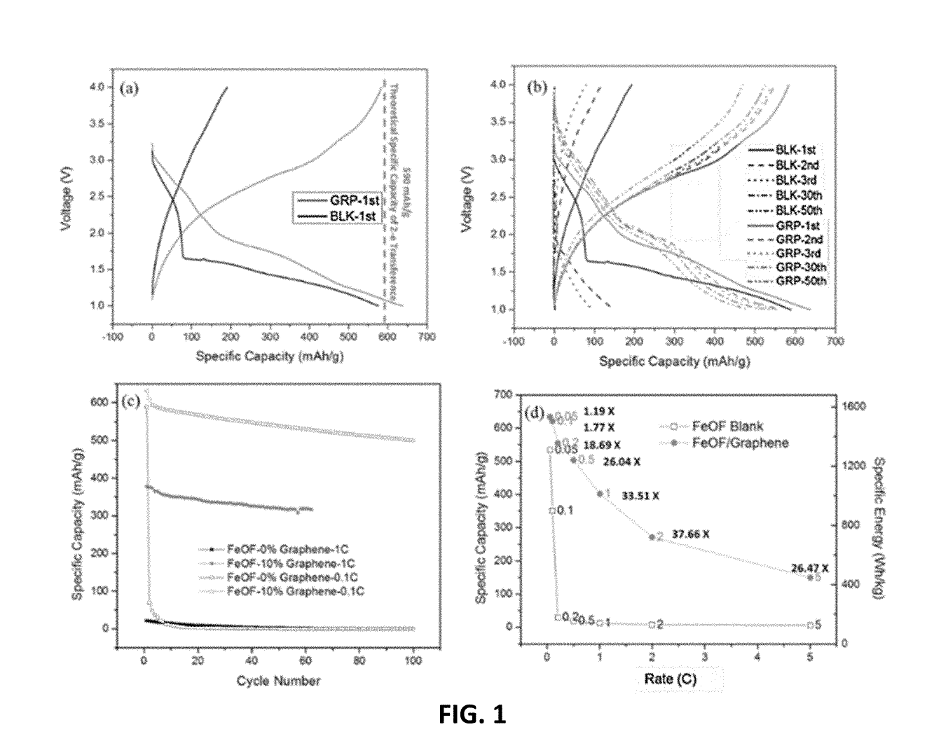

As shown in FIG. 1, the nanostructured FeOF with the incorporated graphene sheets (also labeled “GRP”) showed superior performance to its blank (also labeled “BLK”). The FeOF/graphene achieved 621 mAh/g while FeOF blank only achieved 583 mAh/g (FIG. 1a). More importantly, the FeOF/graphene has much higher Columbic efficiency at 93.9% than the FeOF blank at 32.9%, suggesting that the incorporation of graphene sheet makes the FeOF conversion reaction more reversible. Notably, the FeOF/graphene shows tremendous improvement on the cycle life (FIG. 1b). The FeOF/graphene has a very slow capacity decay rate (0.161%/cycle) and even after 100 cycles, still has 493 mAh/g (78.8% of initial specific capacity and 84.1% of the specific capacity of 3^{rd} cycle), while the FeOF blank immediately dropped to 46 mAh/g (25.0% of initial specific capacity) even after only 4 cycles. It is worthwhile to point out that the decay rates of FeOF/graphene are almost same for different cycling rate (i.e. 0.1 C and 1 C), indicating that the structure of FeOF nanoparticle in the FeOF/graphene composite is very stable, which may offer the superfast charging capability (FIG. 1c). Finally, the rate performance is greatly improved, the FeOF/graphene show 33.51×, 37.66×, and 26.47× improvements over the blank FeOF on 1 C, 2 C, and 5 C, respectively (FIG. 1d). Thus, it has been demonstrated that the performance improvement could be attributed to introduction of graphene which improved the electric conductivity and provide a substrate to stabilize the FeOF particles by morphology observation and structure characterization.

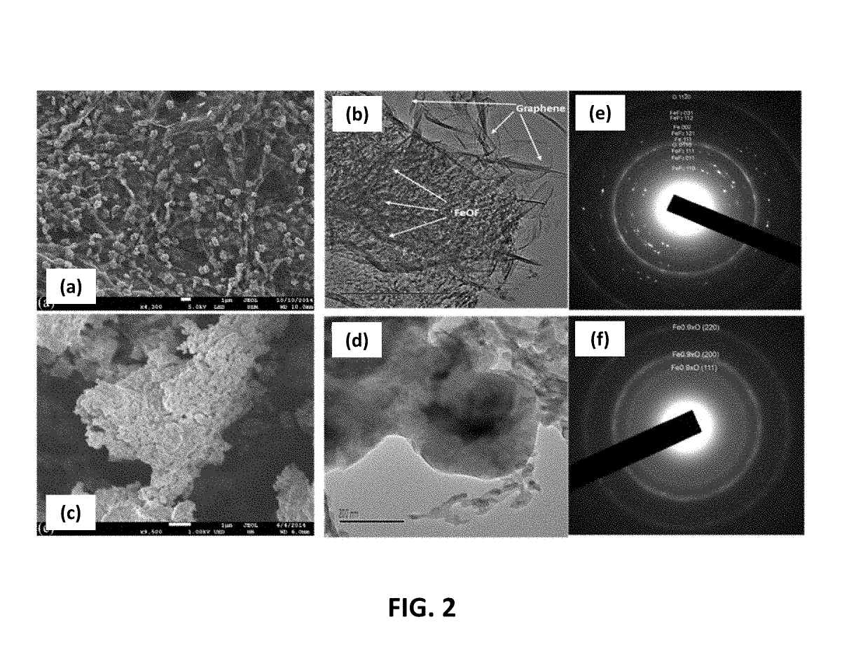

As shown in the SEM and TEM images of FIG. 2, the FeOF/graphene composite material also showed improved FeOF morphology. For the FeOF/graphene composite material (FIGS. 2a and 2c), small, typically spherical or spheroid, FeOF particles (around 1 m) are uniformly formed over the graphene sheet and these particles are made of FeOF nanorods (dia.=3 nm and length=20 nm). For the blank FeOF (FIGS. 2b and 2d), the FeOF particles are big chunks (20-60 μm) with some small particles on the surface (300-500 nm). The diffraction patterns of these materials (FIGS. 2e and 2f) clearly show that the synthesized materials are indeed FeOF. These results show that the graphene nano-sheets serve as substrates to stabilize the structure of FeOF and form a framework to stabilize the Fe clusters through bonding them to their original sites without migration. Thus, the FeOF/graphene composite can keep the (de)lithiation reaction reversible during discharge and charge process.

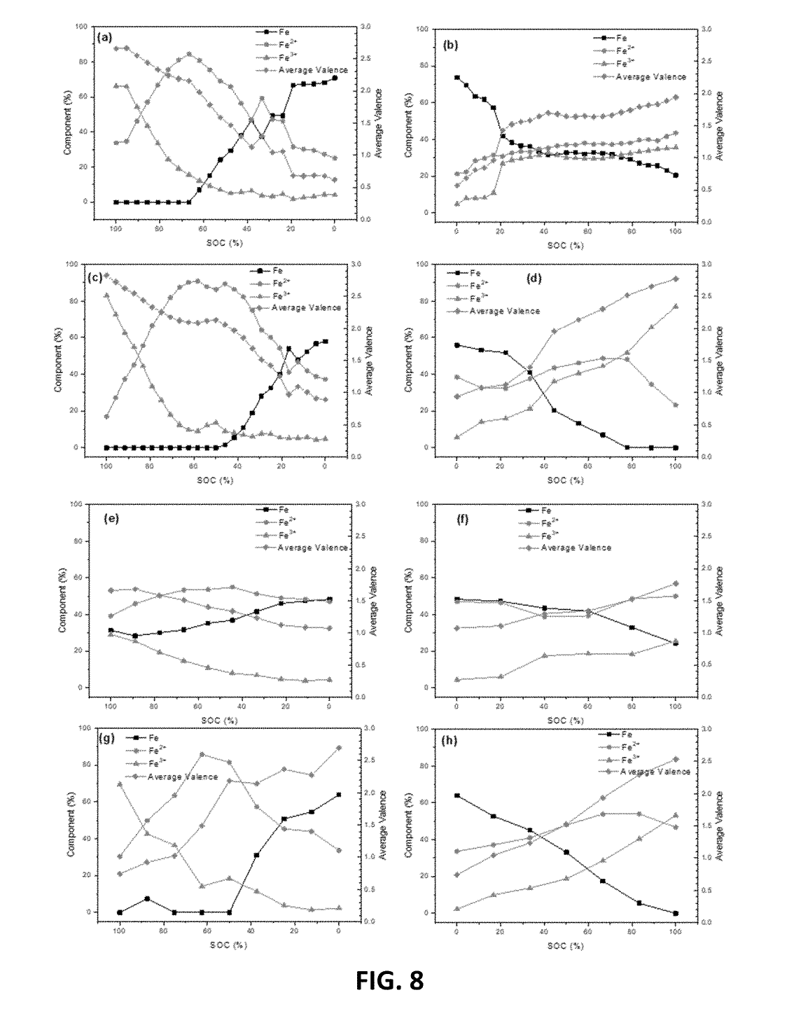

As shown in the XAS spectra of FIG. 8, the existence of graphene sheets was shown to effectively delay the appearance of the metallic Fe in the FeOF/graphene composite: 55% state of charge (SOC) vs. 35% SOC (FeOF/graphene vs. FeOF) (FIG. 8a vs. 8c) during lithiation. The metallic Fe slowly decreases in the FeOF/graphene and disappears at 80% SOC (FIG. 8d) while the metallic Fe decreases but never complete disappears, and maintain a high content in the blank FeOF, 20% during delithiation process (FIG. 8b). The high content of metallic Fe in the blank may indicate that the blank FeOF experiences the irreversible (de)lithiation, which may be resulted from the incomplete reconversion of FeOF, namely, metallic Fe was not transformed back to amphorous rutile FeOF. After 10 cycles, noticeably, there are two significant changes. First, at the delithiated state, no metallic Fe in the FeOF/graphene but a very high amount of metallic Fe in FeOF blank, i.e. 30%. Second, for the FeOF/graphene composite, the metallic Fe appears around 50% SOC, increasing to 60% at the end of lithiation (FIG. 8g), then decreasing to almost 0% at the end of delithiation, following the same patterns as that in the 1^{st} cycle (FIG. 8c). However, for the blank FeOF, during the lithiation process, there is much higher Fe content than that in the 1^{st} cycle, 30% at the beginning of lithiation (FIG. 8e). In addition, these metallic Fe increases to almost 50% at the end of lithiation, and then, decreases to about 27% at the end of delithiation, suggesting that quite large of Fe in blank FeOF does not participate in the conversion reaction. These inactive Fe may suggest the loss of Fe from FeOF, which may be responsible for the capacity loss.

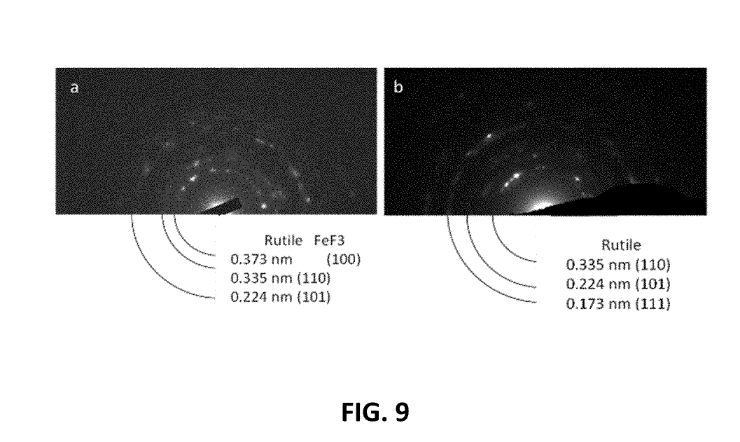

As shown in the TEM diffraction patterns of FIG. 9, both the FeOF blank and the FeOF/graphene composite appear to be rutile structures with small amounts of FeF₃ initially.

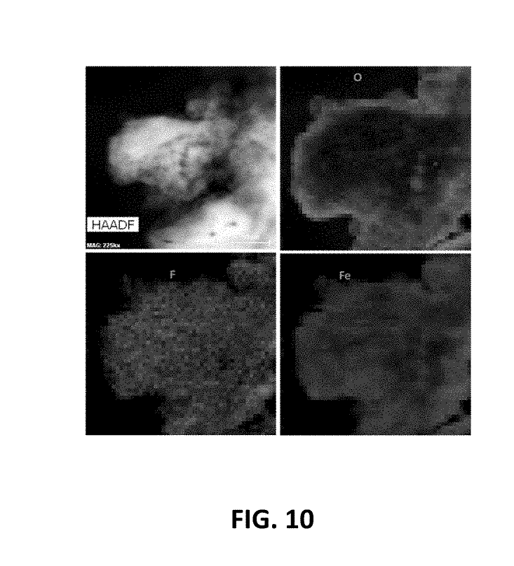

As shown in the EELS images of FIG. 10, after the first lithiaton and delithiation cycle, FeOF particles in the FeOF/graphene composite (taken out from a coin cell) appear to have a core-shell structure with an O-rich shell.

### IV. Stabilized FeOF Using Functionalized Graphenes

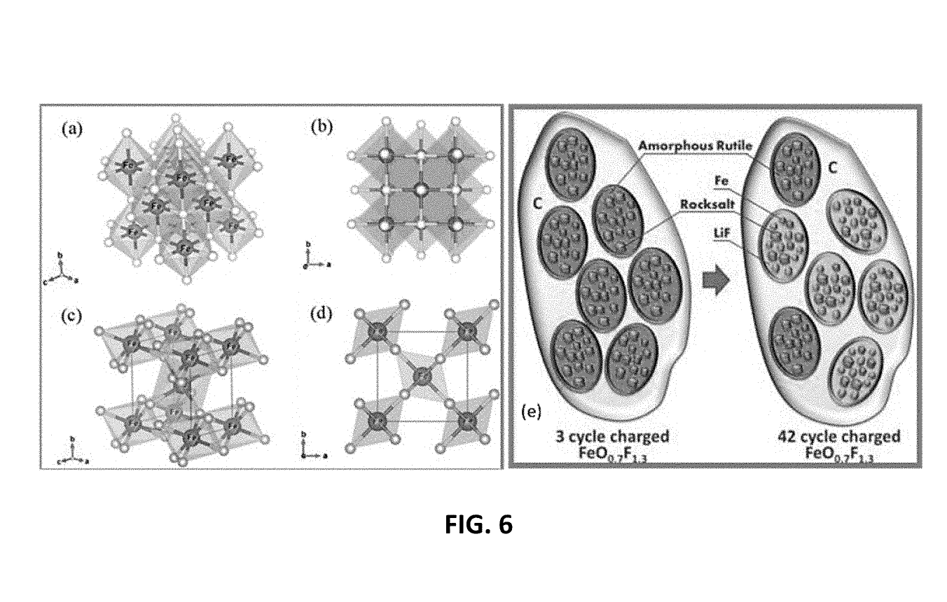

As discussed above with respect to FIG. 3 and as shown in FIG. 6, FeOF is a crystal rutile structure initially and is transformed into a rock salt structure after the first lithiation. Both rutile and rock salt structures are in octahedral arrangement as Fe in the center and O/F on the corners. After the first lithiation/delithiaton cycle, the crystal rutile disappeared and become amorphous rutile. The fully delithiated FeOF has the core-shell structure with F-rich amorphous rutile in the core and O-rich rock salt on the shell while the fully lithiated FeOF has the bcc-Fe nanoparticles in the core and O-rich rock salt on the shell. As the FeOF experiences more and more lithiation/delithiation cycles, some of Fe nanoparticles dissolves in the electrolyte due to the Fe-induced catalytic reactions with electrolyte. Hence, the loss of Fe nanoparticles is one of the major causes of the capacity decay. The present inventors believe that the center Fe in either amorphous rutile or in rock salt octahedral can be stabilized if an additional local electric field is established to affect the ligand field of FeOF. Thus, the graphene may be functionalized to affect the ligand field of FeOF and stabilize the FeOF. Suitable functional groups include carboxylate (—COOH), sulfonate (—SO₃H), hydroxyl (—OH), tertiary amine (NR³⁺, wherein R is H, alkyl, aryl), or combinations thereof. Other suitable polymeric functional groups include polyaniline (PANI), polybenzimidazole (PBI), poly(ethylene oxide) (PEO), polyphenylene oxide (PPO), and/or combinations thereof.

In certain embodiments, the functional groups may be covalently grafted onto the surface of the graphene sheets through a diazonium salt via a diazonium reaction. The diazonium reaction-based functionalization is a simple and cost-effective way to transform the pure graphene sheets into hierarchical and functional materials that can provide the desired properties (i.e. hydrophobicity, Li⁺/e⁻ conductivity, nanoparticle dispersion and local electric field, etc.) and the functionalized graphene sheets for FeOF nanoparticles to anchor. In addition, such a method is easy for large-scale manufacturing.

The cycle life data for different functional groups is shown in Table 2 below. The —COOH functional group had a positive impact on cycle life, whereas the —OH functional group had a negative impact on cycle life, possible due to the stereo effect of the charged groups.

TABLE 2

| | Initial Capacity | Decay Rate | Cycle |
|---|---|---|---|
| Materials | (mAh/g) | (per cycle) | Life |
| FeOF | 595 | 9.8% (first 10 cycles) | 1 |
| | | 0.996% (first 100 cycles) | |
| FeOF/Graphene | 621 | 0.212% | 92 |
| FeOF/Graphene- | 574 | 0.161% | 124 |
| COOH | | | |
| FeOF/Graphene- | 625 | 0.322% | 62 |
| OH | | | |

### V. Coated FeOF Particles

Except for the loss of Fe nanoparticles in the fully lithiated FeOF due to the dissolution, the further cycling of FeOF causes the formation of excess LiF, which is insulated and prevents further delithiation, which is another cause of capacity fading. In certain embodiments, an ultra-thin polymer coating or protection layer with good electronic conductivity may be uniformly coated over the surface of a FeOF nanoparticle. An exemplary coating layer is PANI, which is electrically conductive (6.28×10⁻⁹ S/m) and its conductivity can be enhanced by HBr doping, 4.60×10⁻⁵ S/m (4% HBr doping). Other suitable polymeric coatings include PBI, PEO, PPO, and/or mixtures thereof, for example. The graphene sheets may hold the coated FeOF nanoparticles together to protect the FeOF nanoparticles from Fe dissolution and LiF formation, and, consequently, extend the cycle life. The coating may also be transformed into a carbon layer through the pyrolysis to enhance the electric conductivity.

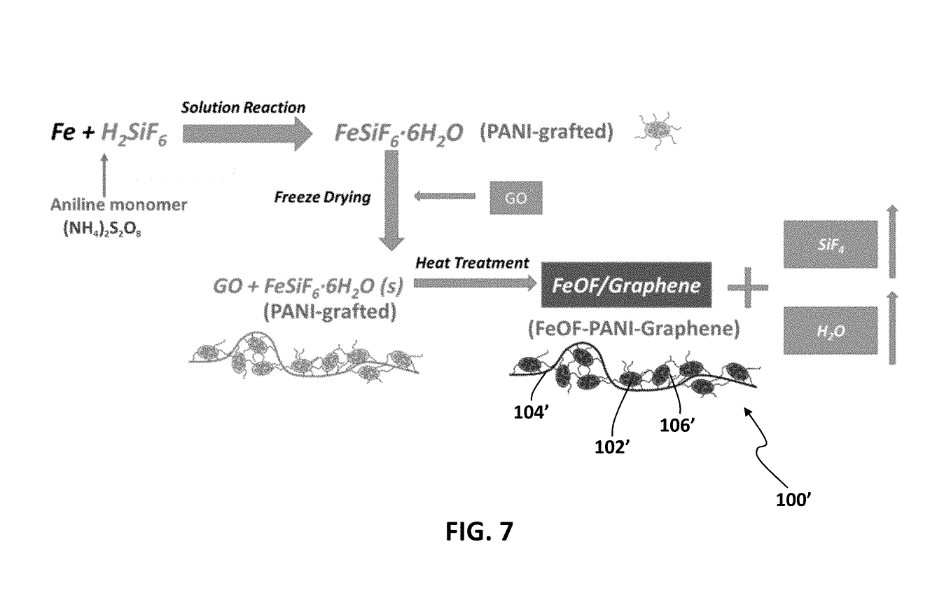

FIG. 7 illustrates an exemplary method for synthesizing a coated FeOF/graphene composite 100′, including FeOF nanoparticles 102′ with a PANI coating 106′ dispersed over graphene sheets 104′. The method and product of FIG. 7 may be similar to the method and product of FIG. 4 described in Section III above, except that the FeOF precursor may be formed in the presence of a coating monomer. For example, the iron metal powder and the H₂SiF₆ may be combined with an aniline monomer such that the coating is polymerized in situ over the surface of the formed FeSiF₆ nanoparticles. The thickness of the coating may be controlled by the content of the monomer. Other suitable monomers in addition to aniline include pyrrole, thiophenes, thylenedioxythiophene, and/or mixtures thereof, for example.

One interesting aspect of the present novel technology arises from the synergetic approach of (1) incorporating graphene sheets into FeOF nanostructure to make the FeOF reversible conversion materials with excellent performance, and (2) interaction with the (de)lithiation mechanism of metal oxyfluorides using synchrotron XAS and TEM to guide the material development. Unlike most of LIB materials such as LiCoO₂, LiFePO₄, LiMn₂O₄ and V₂O₅ etc., which are either toxic (i.e. V₂O₅), expensive (i.e. LiCoO₂) and/or of low specific energy (i.e. LiFePO₄) and/or of low cycle life (LiMn₂O₄), the proposed novel graphene incorporated nanostructured FeOF/graphene composites are non-toxic, low cost, and high specific energy (i.e. 1720 Wh/kg, 3× of LiCoO₂, LiMn₂O₄ and LiFePO₄), which are the most promising cathode materials for the next generation of LIBs. The incorporation of graphene sheets into metal oxides and metal oxyfluorides was shown to improve the electric conductivity, manipulate the particle morphology, and maintain their structural integrity during the (de)lithiation process, which opens a new avenue for effectively developing novel conversion and other electrode materials.

Advantages of the approach of graphene modified materials over the current electrode materials include (1) a simple effective incorporation of the graphene sheets can significantly change the materials in terms of morphology, structure and performance; (2) the incorporation of graphenes, particular the functionalized graphenes provides an effective and robust tool for tailoring the materials to achieve the desired properties (i.e. surface hydrophobic, intra/interparticle electric conductivity, particle size and morphology, etc.) and (3) the incorporation is cost effective: high-quality graphene of high surface area may be produced made by the simple oxidation of natural graphite powders. Graphene incorporated FeOF composites may greatly advance the battery industries, consequently, leading the break-through on portable electronics, and electrification of the automobiles as required by many countries.

This unique and non-conventional approach of incorporating graphene sheets into metal oxides and metal oxyfluorides to tailor the materials' morphology and structure makes the FeOF/graphene composite reversible conversion materials with a high specific capacity/energy, high rate, high cyclability, and high safety. This approach can be realized by simply incorporating graphene oxide sheets in the FeOF synthesis process, leading to a novel, graphene modified and nanostructured FeOF composites, yielding a reversible conversion material with a specific energy 3× that of the current LiFePO₄ with at least 1000 cycles that is ready for commercial applications.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

### EXAMPLES

### 1. Example 1: FeOF Cathode

FeOF was recently found to be a conversion type cathode material for LIBs because of its high theoretical capacity (885 mAh). Rutile structure FeOF was both environmental friendly and economic. During the charge and discharge process, the valence of iron changes from 3+ to 0, which means that it can deliver 3 electrons. However, the cyclability of this cathode was still too poor. In order to increase the cycle life of FeOF, it is very important to clearly elucidate the failure mechanism by clearly understanding the atom environment in real-time during the cycling.

Synchrotron X-ray near-edge structure (XANES) is very helpful for illustration of the local structure and state of charge of the element of interest. With the help of XANES, in-situ characterization of FeOF cathode is made to better elucidate real-time local structure and valence change at different state of charge (SOC) and depth of discharge (DOD) in order to better illustrate the mechanism of the iron ion evolution and FeOF failure mechanism. FeOF was prepared and mixed with carbon black, PVDF and NMP to form a uniform slurry. The cathode was prepared by coating the slurry on aluminum foil. The in-situ test coin cell was assembled by FeOF cathode, Celgard separator and lithium foil anode and was sealed in our home-made coin cell shell. K-edge of Fe was measured during the in-situ characterization to observe the valence change and local structure evolution during the discharge and charge process between the voltage range of 4V and 1V.

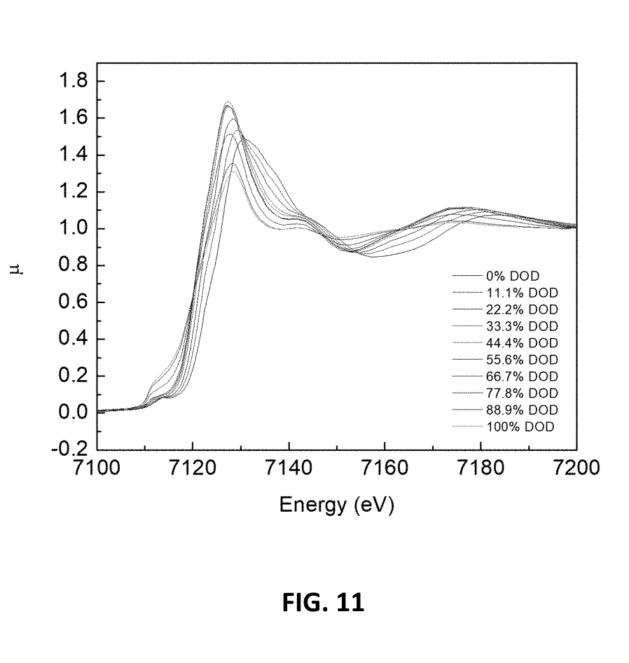

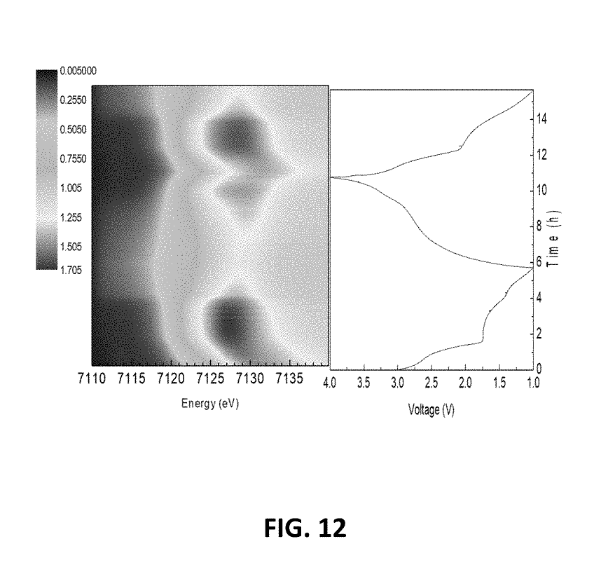

The in-situ XANES spectrum is plotted in FIG. 11. From 0% DOD to around 50% DOD, the K-edge shifts to low energy direction and then shifts back to high energy direction. This phenomenon indicates that there are two different mechanism during discharge process. To better analyze the in-situ XANES data, the contour plot and the charge/discharge profile were shown in FIG. 12. The XANES and charge/discharge profile correlated with each other very well. At the beginning of discharge process, the K-edge shifts towards low energy direction and the intensity increases gradually, which means this is a Li⁺ intercalation process. At the end of the discharge process, the K-edge shifts back to the high energy direction and there is a sharp intensity change which corresponding to the conversion process. Similar conversion and deintercalation process can be observed at the beginning and end of the charge process respectively.

In conclusion, by applying in-situ XANES technique, we can clearly visualize the valence and local structure evolution mechanism during real working condition and get our preliminary conclusion that the charge/discharge process of FeOF battery contains two typical processes: Li+ intercalation occurs at high voltage range and conversion process occurs at lower voltage range.

### 2. Example 2: Graphite Nanoparticles

Synthesis of the Generally Sphere-Like Graphite Nanoparticles:

An isotropic petroleum pitch was heat-treated in a furnace. This furnace included a cylindrical stainless steel reactor, fitted with an anchor-type stirrer and a thermocouple connected to a temperature controller/microprocessor. The reactor was heated using a cylindrical furnace. The reactor was loaded with 400 grams of the precursor pitch and heated at a rate of 3 degrees Celsius per minute until the desired soak temperature of 420 degrees Celsius was achieved. The precursor pitch particles were generally spherical in shape and were soaked at 420 degrees Celsius for 2 hours. During the heat treatment, an agitation of 70 rpm was maintained as was a flow of nitrogen gas at a rate of 0.5 cubic meters per hour for removal of any evolved volatile materials.

In order to separate the spherical particles from the parent pitch, first the heat treated pitch was mixed with wash oil and then filtered at 100 degrees Celsius, followed by three successive washes with toluene, at 75 degree Celsius in a water bath, and then centrifuged for separation. The separated particles were dried and successively oxidized in air at 200 degrees Celsius for 5 hrs, carbonized at 1000 degrees Celsius for 15 min, and graphitized at 2800 degrees Celsius.

Preparation of the Nano Graphite Particles:

The acid bath was composed of nitric acid (70%), sulfuric acid (98%) and perchloric acid (60%) present in a ratio of 1:6:1 (v/v), respectively. For each batch of graphite nanoparticles, 5 g graphite powder was placed into the etching acid bath and heated to about 200 degrees Celsius while being constantly stirred. Two samples were prepared by heating for 1 hour and 2 hours, respectively. For the separation of the etched samples, the mixture was centrifuged at 15000 rpm and each sample was washed with distilled water for 5 times.

Characterization:

High-resolution TEM images were obtained using a transmission electron microscope. The electron beam accelerating voltage of the TEM was 200 kV for all images. All the samples were suspended in ETOH, drop-cast onto a lacey-carbon TEM grid (SPI), and the solvent was allowed to completely evaporate. The morphologies of the graphite spheres and the etched samples were examined using cold field emission scanning electron microscopy. The crystalline structure of the graphite spheres and the etched samples were investigated using X-ray wide angle diffraction. The diffractometer utilized Cu Kα radiation (40 kV and 30 mA). The data were collected as continuous scans, with a step size of 0.020 (20) and a scanning rate of 20 (20)/min between 10-900 (20). The surface chemistry of the raw graphite spheres and acid etched samples was analyzed using X-ray photoelectron spectrometry. The spectrometer had an Al Kα X-ray source. An electron flood gun for charge neutralization and a hemispherical analyzer with 8 multichannel photomultiplier detectors was employed for analysis. The area of analysis was 700×300 microns in size. The XRD results for confirmed the material to be essentially pure graphite from the 100 and 101 characteristic peaks at 42.22 and 44.39 degrees, respectively, and the TEM diffraction pattern results indicated a layer d-spacing of about 3.4 Å, as compared to the ideal d-spacing for graphite of 3.35 Å, confirming graphite.

### 3. Example 3: GO Solution

A GO solution was prepared using a modified Hummer's method. 2 grams of graphite flakes were mixed with 10 mL of concentrated H₂SO₄, 2 grams of (NH₄)₂S₂O₈, and 2 grams of P₂O₅. The obtained mixture was heated at 80° C. for 4 hours under constant stirring. Then the mixture was filtered and washed thoroughly with DI water. After drying in an oven at 80° C. overnight, this pre-oxidized graphite was then subjected to oxidation using the Hummer's method. 2 grams of pre-oxidized graphite, 1 gram of sodium nitrate and 46 mL of sulfuric acid were mixed and stirred for 15 minutes in an iced bath. Then, 6 grams of potassium permanganate was slowly added to the obtained suspension solution for another 15 minutes. After that, 92 mL DI water was slowly added to the suspension, while the temperature was kept constant at about 98° C. for 15 minutes. After the suspension has been diluted by 280 mL DI water, 10 mL of 30% H₂O₂ was added to reduce the unreacted permanganate. Finally, the resulted suspension was centrifuged several times to remove the unreacted acids and salts. The purified GO were dispersed in DI water to form a 0.2 mg/mL solution by sonication for 1 hour. Then the GO dispersion was subjected to another centrifugation in order remove the un-exfoliated GO. The resulted GO dilute solution could remain in a very stable suspension without any precipitation for a few months.

### 4. Example 4: FeOF and FeOF/Graphene Cathodes

Two FeSiF₆-6H₂O solutions were heated to 120° C. and then to 200° C. under 02 gas flow. To one sample, a dilute GO solution was added and further processed to form FeOF particles with 10 wt. % graphene. The resulting blank FeOF and FeOF/graphene materials were assembled as cathodes in coin cells using Li metal anodes and dielectric separators with electrolytes including 1.0 M LiPF6 in a 3:7 by weight solvent mixture of EC and EMC for electrochemical testing.

1. A composite electrode material comprising:
a plurality of graphene sheets; and
a plurality of FeOF nanoparticles anchored to each graphene sheet.

2. The material of claim 1, wherein the material comprises about 1 wt. % to about 10 wt. % of the graphene sheets.

3. The material of claim 2, wherein the material comprises about 2 wt. % of the graphene sheets.

4. The material of claim 1, wherein the graphene sheet is functionalized with at least one functional group selected from carboxylate, sulfonate, hydroxyl, and tertiary amine.

5. The material of claim 1, wherein the FeOF nanoparticles have a polymeric coating.

6. The material of claim 5, wherein the polymeric coating is selected from PANI, PBI, PEO, PPO, and combinations thereof.

7. The material of claim 1, wherein the material has a specific capacity of at least 1700 Wh/kg.

8. The material of claim 1, wherein the material has a rate capability of at least 500 mAh/g measured at a 5 C rate.

9. The material of claim 1, wherein the FeOF nanoparticles are rutile structures.

10. The material of claim 1, wherein the FeOF nanoparticles have an oxygen-rich shell.

11. The material of claim 1, wherein the FeOF nanoparticles are nanorods having an average diameter of 3 nm and an average length of 20 nm.

12. A battery comprising an electrode with the material of claim 1.

13. The battery of claim 12, wherein the battery is configured for use in a portable electronic device, an electric vehicle, or an energy storage device.

14. A method of manufacturing a composite electrode material comprising:
preparing a solution comprising FeSiF₆ and graphene oxide in a solvent;
heating the solution to convert the FeSiF₆ to FeOF; and
reducing the graphene oxide to graphene.

15. The method of claim 14, wherein the heating step is performed at a temperature of about 200-240° C.

16. The method of claim 14 wherein the solvent is selected from water, methanol, ethanol, N-Methyl-2-pyrrolidone (NMP), benzyl alcohol, and combinations thereof.

17. The method of claim 14, wherein the reducing step is performed at a temperature of about 200-350° C.

18. The method of claim 14, further comprising adding a monomer to the solution and polymerizing the monomer to form a coating on the FeSiF₆.

19. The method of claim 14, further comprising covalently grafting functional groups onto the graphene.

20. The method of claim 14, further comprising freeze-drying or spray-drying the solution between the heating step and the reducing step.
